(19) United States
(12) Patent Application Publication
(10) Pub. No.: US 2025/0266608 A1
(43) Pub. Date: Aug. 21, 2025

(54) IN-THE-EAR HEARING AID

(71) Applicant: Sivantos Pte. Ltd., Singapore (SG)

(72) Inventors: Hamed HASANI, Erlangen (DE); Andreas PFROMMER, Erlangen (DE)

(21) Appl. No.: 19/055,735

(22) Filed: Feb. 18, 2025

Related U.S. Application Data
(63) Continuation of application No. PCT/EP2024/053790, filed on Feb. 15, 2024.

(51) Int. Cl. H01Q 1/22; H01Q 1/36; H04R 25/00; H04R 25/02

(52) U.S. Cl. CPC H01Q 1/22; H01Q 1/362; H04R 25/02; H04R 25/554; H04R 2225/025

(57) ABSTRACT

An in-the-ear hearing aid has a housing with a transmitting and receiving unit arranged therein and has an arc-shaped antenna element emerging from the housing, which is at least part of a handle element, with the aid of which the hearing aid is removable from the ear by the user. The antenna element has at least one helical conductor strand, which is used for transmitting or receiving a signal and which is connected to the transmitting and receiving unit arranged in the housing. An efficient, discrete antenna element is formed by this configuration.

### CROSS-REFERENCE TO RELATED APPLICATION

This application is a continuation, under 35 U.S.C. § 120, of copending International Patent Application PCT/EP2024/053790, filed Feb. 15, 2024, which designated the United States; the prior application is herewith incorporated by reference in their entirety.

### FIELD AND BACKGROUND OF THE INVENTION

The invention relates to an in-the-ear hearing aid, in particular a hearing aid device, having a housing having a transmitting and/or receiving unit for electromagnetic waves arranged therein and having an arc-shaped antenna element emerging from the housing, which is at least part of a handle element, with the aid of which the hearing aid is removable from the ear by the user.

Such a hearing aid having a bow-shaped or loop-shaped antenna element integrated into a handle element is disclosed in European patent EP 3 491 846 B1, corresponding to U.S. Pat. No. 10,735,873.

Such a hearing aid is also disclosed in U.S. Pat. No. 11,496,843 B2, in which the antenna element is made arc-shaped.

Hearing aid devices are portable hearing aids which are used to treat the hard of hearing or the hearing impaired.

In-the-ear hearing aids (ITE hearing aid) are compactly configured hearing aids which have a housing to be placed in-the-ear of the user, in which preferably all electrical components required for the hearing aid (except for the antenna element) are installed. ITE hearing aids are available in different variants and are worn, for example, on the outer ear or in the auditory canal.

Due to the small installation space, it is advantageous to arrange the antenna element at least partially outside the housing and integrate it into the handle element. In the known hearing aids, this handle element often protrudes from the ear of the user, which is viewed as visually less discreet.

The antenna element is regularly configured as an RF antenna. The hearing aid can be coupled for signaling via this antenna, for example, with an operating element (remote control), an audio source, and/or with a further hearing aid. A Bluetooth connection is often used for this purpose. In general, the same antenna element is used for transmitting and receiving signals for reasons of space.

### SUMMARY OF THE INVENTION

The invention is based on the object of specifying an ITE hearing aid having a compact, discrete, and efficient antenna element.

The object is achieved according to the invention by an in-the-ear hearing aid (ITE hearing aid) having a housing having a transmitting and receiving unit arranged therein and having an arc-shaped antenna element emerging from the housing, which is at least part of a handle element, wherein the hearing aid is removable from the ear by the user with the aid of the handle element. The arc-shaped antenna element has at least one helical conductor strand, which is designed for transmitting or receiving a signal, in particular an RF signal (radio frequency), and is connected to the transmitting and receiving unit.

An arc-shaped antenna element is understood to mean that the antenna element itself extends along an arc element. The helical conductor strand is fundamentally designed as a helix. This helix is also arc-shaped, thus extends along an arc element, i.e. in addition to the turns of the conductor strand which form the helix, the conductor strand is additionally curved, so that it is formed arc-shaped.

An effective antenna length is increased with compact construction by the helical conductor strand. In combination with the curved design, a very compactly constructed antenna having high efficiency is therefore achieved overall, which is discreetly designed as visually appealing.

An RF signal is alternately received or transmitted via the helical conductor strand. The received signal is therefore forwarded to the transmitting and receiving unit and processed therein in operation. For transmission, vice versa, a corresponding antenna signal (RF signal) is coupled into the helical conductor strand from the transmitting and receiving unit and emitted via the helical conductor strand.

The antenna formed by the antenna element is an RF antenna, i.e. an antenna which is designed to transmit or receive in a frequency band of a radio frequency. Typical frequency bands are in the megahertz range (e.g., 433 MHz, 800 MHZ, 915 MHZ) and in particular also in the gigahertz range (e.g., 1.8 GHz, 2.4 GHz, 5.8 GHZ).

The hearing aid is generally a hearing aid device which is configured to compensate for user-specific hearing deficits.

The hearing aid has as essential electrical (hearing aid) components within the housing an input transducer, an amplifier, and an output transducer. The input transducer is generally an acoustoelectric transducer, such as a microphone. The output transducer is usually designed as an electroacoustic transducer, for example as a miniature loudspeaker (receiver). The amplifier is typically integrated into a digital signal processing unit. This is used to process an input signal to form an output signal, in particular in a known manner such that user-specific hearing deficits are compensated for. The energy supply is typically carried out by a battery.

Some of these components, especially the signal processing unit, the transmitting and receiving unit, and, for example, also the microphone are typically arranged on a so-called faceplate in the ITE hearing aid.

In general, the antenna element has a number of helical conductor strands, wherein the number is at least 1. According to one preferred embodiment, at least two helical conductor strands are formed, which are intertwined. This is understood to mean that the individual turns of the two conductor strands are arranged alternately, thus that-viewed in a top view-an arc section of one conductor strand is arranged between two adjacent arc sections of the other conductor strand. The two helical conductor strands therefore form a double helix. Due to the fundamentally arc-shaped design, both conductor strands extend in an arc shape.

Particularly good mutual coupling between the two conductor strands is achieved by this design having the intertwined (interwoven) conductor strands, which results overall in a high efficiency. In particular, the so-called Q factor of the antenna is improved at the resonance frequency of the antenna, due to which the good efficiency results.

Due to the design as a double helix, thus fundamentally as two coils intertwined with one another having the good mutual coupling, an effective (coil) inductance is advantageously 4 times that in comparison to a single coil arrangement.

Due to the design described here as a double helix, in particular having conductor strands connected to one another, the antenna can also be designated as a whole as a folded (monopole) antenna. This permits a simpler adjustment/setting of the impedance, for example, in the range of 50 ohm. This is in particular significantly higher than in a single coil having a short coil length.

The particularly good efficiency is achieved in particular in a design in which the (two) conductor strands are connected to one another and more or less form a continuous conductor strand, as will be explained hereinafter.

In particular, the one conductor strand extends from the arc beginning of the antenna element to the arc end of the antenna element, merges there into the second conductor strand, which then in turn extends from the arc end to the arc beginning.

The two helical conductor strands are in particular formed identically, i.e. in particular they have the same number of turns, preferably consist of the same material, and each have, for example, an equal conductor thickness/conductor width. The efficiency and performance of the antenna can be improved by the multiple conductor strands.

In a preferred embodiment, one of these helical conductor strands is grounded (also referred to hereinafter as a grounded conductor strand). In addition to the conductor strand, via which the signal is transmitted or received, and which is also referred to hereinafter as an active conductor strand, a ground band extending more or less in parallel is therefore arranged, which has a positive effect on the efficiency of the antenna.

This grounded conductor strand is directly connected to ground potential at one end according to a first embodiment variant. Alternatively, the ground connection takes place indirectly via a passive component, for example via a capacitive component part, an inductive component part, or also an (ohmic) resistor. For example, this grounded conductor strand is connected to a ground line formed on the above-described faceplate via a suitable ground connection.

In a further preferred embodiment, more than two helical conductor strands are formed. The properties of the antenna can furthermore be set suitably in accordance with the requirements via the number of the helical conductor strands.

Especially, multiple conductor strands are grounded. In this way, for example, the area of the ground element which is formed by the multiple helical grounded conductor strands is set suitably, by which the properties of the antenna can in turn be set as desired. The grounded conductor strands are connected here, for example, to one another at least at one end.

The arc-shaped antenna element emerging from the housing generally extends outside the housing from the beginning to an end. The beginning forms an arc beginning and the end forms an arc end. The at least one and in particular both/all helically wound conductor strands preferably also extend in an arc shape from a first end at the beginning of the antenna element to a second end at the end of the antenna element. I.e. the at least one helical and curved conductor strand extends over the entire length of the arc-shaped antenna element. A high effective antenna length is achieved on a short installation space by the extension of the at least one helically wound conductor strand over the entire length.

A very space-saving and compact antenna is achieved in that the conductor strand extends over the entire arc length. In particular in connection with the design as a double helix having the two conductor strands, a highly miniaturized antenna having high efficiency is achieved.

The active conductor strand is in particular connected with its first end to the transmitting and receiving unit.

In the at least one grounded conductor strand, its first end is preferably likewise connected to the ground potential.

According to a first embodiment variant, the at least one helical conductor strand is open at its second end, thus has a free end.

In the embodiment variant having at least two conductor strands, these are preferably open at the end according to one preferred variant, therefore each have a free end.

According to a particularly preferred embodiment variant alternative thereto, the two conductor strands, thus in particular the active conductor strand and the grounded conductor strand, are directly connected to one another at the respective second end and therefore short-circuited, as was already previously explained.

In principle, the antenna properties can be set in a variety of ways with compact installation space due to the design having the helically wound conductor strands.

In a preferred embodiment, an impedance of the antenna element is set to a desired value of, for example, 50 ohm by the number of the helically wound conductor strands. The value of the impedance varies in particular as a function of the number of the grounded conductor strands.

Furthermore, an effective antenna length is set and therefore in particular also a desired transmitting and receiving frequency by the number of the turns of the at least one helically wound conductor strand (at predetermined diameter of the helix formed by the conductor strand). For example, the antenna element is set to one of the above-mentioned transmitting and receiving frequencies, especially to a frequency of 2.4 GHz or also 5.8 GHz.

In one preferred embodiment, the antenna element has a curved carrier, around which the at least one conductor strand is helically wound. Preferably, all helically wound conductor strands are applied to this carrier or attached thereon. I.e. the conductor strands press directly against this carrier. It is therefore formed circular in cross section. It is thus formed like a curved cylinder, for example a curved round bar or a curved round tube. The carrier consists in particular of an insulation material here, in particular plastic.

According to one preferred embodiment, the at least one conductor strand is and all conductor strands are formed by a metallization applied to the carrier, thus by a metal layer applied to the carrier. The individual conductor strands are therefore formed as flat conductor tracks attached to the carrier by material bonding.

The respective conductor strand is especially formed by corresponding structuring, especially by (direct) laser structuring. For this purpose, a procedure is preferably performed such that initially a metallization and therefore a metal layer is applied to the carrier all over and in particular fully and preferably over its entire length. Parts of the applied metal layer are then removed again by the structuring, especially with the aid of a laser, so that the helically wound conductor strands are thus formed. These are subsequently contacted in a suitable manner at the first end and, for example, connected in a wired manner to the transmitting and receiving unit or to a ground connection.

Alternatively to the design of the conductor strands like conductor tracks formed by metal layers, the conductor strands are formed by preferably bare, possibly also insulated wires, which are thus wound helically around the carrier.

In general, a mechanically stable support structure for the antenna element is formed by the carrier, so that a sufficient mechanical stability for the function as a handle element is ensured.

In one preferred embodiment, the antenna element is detachably attached to the housing via a coupling point. This coupling point is designed in particular like a plug-in coupling and, for example, as a socket. The antenna element is therefore preferably inserted with its beginning into a socket-shaped receptacle on the housing. Contact elements, in particular spring mounted contact elements, are attached inside this socket, for example, via which a respective conductor strand is electrically contacted and is connected to the transmitting and receiving unit or to ground. The antenna element can preferably be locked suitably in a formfitting manner, for example by a bayonet fitting.

Preferably, only the one end, namely the beginning of the antenna element, is coupled and connected in a mechanically fixed manner to the housing. The opposite end of the arc-shaped antenna element, in contrast, is formed as a free end and is not connected to the housing.

In a preferred refinement, the antenna element forms a half arc, thus extends over an angle range of approximately 180° (for example, over an angle range between 150° and 180°). The end of the antenna element in particular faces again in the direction toward the housing here. This end is preferably only slightly (at most 5 mm, at most 3 mm) spaced apart from the housing. Overall, the antenna element only extends above a surface area formed by an end wall of the housing, thus does not protrude laterally beyond the housing. This end wall and therefore the handle element face away from the ear canal of the hearing aid wearer in the worn state. Overall, an arc-shaped handle element is advantageously formed by the half arc-shaped design, which is accommodated discreetly inside the ear of the user and does not protrude. At the same time, this arc-shaped handle element can be grasped well by the user.

Other features which are considered as characteristic for the invention are set forth in the appended claims.

Although the invention is illustrated and described herein as embodied in an in-the-ear hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

An embodiment variant of the invention will be explained in more detail hereinafter on the basis of the figures.

### BRIEF DESCRIPTION OF THE FIGURES

FIG. 1 is a diagrammatic, perspective view of an ITE hearing aid, having an arc-shaped antenna element which has multiple helically wound conductor strands;

FIG. 2 is a side view of the arc-shaped antenna element; and

FIG. 3 is a perspective view of the arc-shaped antenna element.

### DETAILED DESCRIPTION OF THE INVENTION

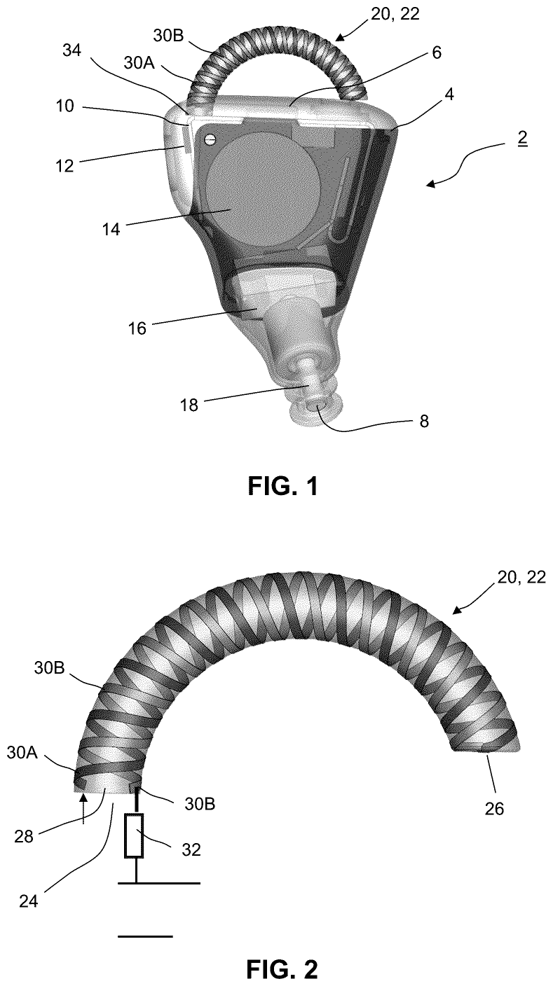

Referring now to the figures of the drawings in detail and first, particularly to FIG. 1 thereof, there is shown an ITE hearing aid 2 having a housing 4, which is shown transparent here and which at one end has a terminal end wall 6 and at its opposite, tapered end has a sound exit opening 8.

The ITE hearing aid 2 is placed during use in the ear of a user, in particular in the outer ear.

A faceplate 10 is arranged inside the housing 4, which faceplate is designed, for example, as a curved and/or folded circuit board. Multiple electrical components are installed thereon, in particular a transmitting and receiving unit 12 for transmitting and receiving RF signals. In addition, a digital signal processing unit, a microphone, etc., which are not explicitly shown in the present case, however, are in particular also arranged on the faceplate 10.

Furthermore, a battery 14 is installed in the housing 4. A receiver 16, thus an electroacoustic output transducer, which has a sound channel 18 at the end, which forms the sound exit opening 8 at the end, is arranged in the direction toward the sound exit opening 8 and in particular below the battery 14.

An arc-shaped antenna element 20 emerging from the housing 4, i.e. arranged outside the housing 4, which is at the same time part of an arc-shaped handle element 22, is attached to the end wall 6. The hearing aid 2 can be manually grasped by the user at this arc-shaped handle element 22, which is used, for example, to remove the hearing aid 2 from the normal wearing position.

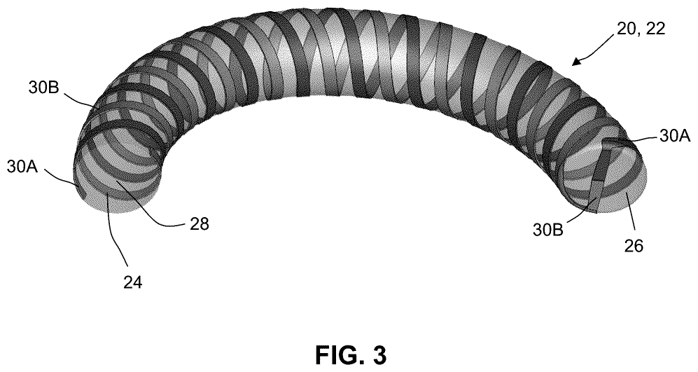

The antenna element 20 is shown enlarged in FIG. 2 and FIG. 3. The arc-shaped antenna element 20 generally extends from a beginning 24 to an end 26 of the arc formed. The antenna element 20 in particular extends over the entire length of the handle element 22.

The antenna element 20 has a curved carrier 28, on which in the exemplary embodiment two helically wound conductor strands, namely an active conductor strand 30A and a grounded conductor strand 30B, are attached. The carrier 28 is shown transparent in the figures in order to make the helical course of the conductor strands 30A, 30B well visible. The two conductor strands 30A, 30B are intertwined, so that individual turn sections of the two conductor strands 30A, 30B thus extend adjacent to one another.

The two conductor strands 30A, 30B preferably extend over the entire length or at least nearly the entire length (>90%) of the carrier 28.

The conductor strands 30A, 30B preferably extend from the beginning 24 to the end 26 of the arc-shaped antenna element 20.

The active conductor strand 30A is used for transmitting or receiving a signal, especially an RF signal. The active conductor strand 30A is coupled with the above-described transmitting and receiving unit 12 and in particular is connected by an electrically conductive connection, which is not shown in more detail here.

The grounded conductor strand 30B is connected to ground potential, wherein an embodiment variant is shown in the exemplary embodiment in which the grounded conductor strand 30B is indirectly connected to the ground potential via a passive electrical component part 32, such as a capacitor, a coil, or also an ohmic resistor, for example.

As can be seen in particular in FIG. 3, the two conductor strands 30A, 30B are directly connected to one another at the end, i.e. at the end 26 of the antenna element 20, and therefore short-circuited.

The arc-shaped antenna element 20 is mechanically connected to the housing 4 with its beginning 24 and preferably only with its beginning 24. The opposite end 26, in contrast, is formed as a free end, which is arranged spaced apart at least somewhat from the housing 4 and in particular spaced apart from the end wall 6.

The housing 4 and in particular the end wall 6 in particular have a coupling point designed as a socket 34 at an edge area, into which socket the antenna element 20 is inserted with its beginning 24. A reversibly detachable fastening is preferably enabled via this socket 34, so that the antenna element 20 designed as a handle element 22 can thus also be reversibly installed on the housing. For example, this takes place via a bayonet fitting.

Contact elements, via which the conductor strands 30A, 30B are contacted, are in particular installed inside the socket 34. The socket 34 is, for example, fastened on the faceplate 10 and electrically contacted in a suitable manner with conductor tracks formed on the faceplate 10.

As can be seen in particular on the basis of FIG. 1, the arc-shaped antenna element 20 extends from an edge section of the end wall 6 to an opposite edge section, so that the antenna element 20 spans the end wall in an arc shape.

The hearing aid 2 shown is, for example, part of a binaural hearing device, which has a second hearing aid 2, wherein the two hearing aids 2 exchange communication signals with one another via the respective antenna element 20.

In general, the antenna element 20 is designed with an associated transmitting and receiving unit for a Bluetooth communication with a further Bluetooth device. Alternatively, to the second hearing aid, the further Bluetooth device is a remote control and/or an audio device. In particular, it is a smart phone, which functions, for example, as a remote control and/or audio source.

The following is a summary list of reference numerals and the corresponding structure used in the above description of the invention:
2 hearing aid
4 housing
6 end wall
8 sound exit opening
10 faceplate
12 transmitting and receiving unit
14 battery
16 receiver
18 sound channel
20 antenna element
22 handle element
24 beginning
26 end
28 carrier
30A active conductor strand
30B grounded conductor strand
32 electrical passive component part
34 socket

1. An in-the-ear hearing aid, comprising:
a transmitting and receiving unit;
a housing having said transmitting and receiving unit disposed therein; and
arc-shaped antenna element emerging from said housing and forming at least part of a handle element, with an aid of said handle element the hearing aid is removable from an ear by an user, said arc-shaped antenna element having at least one helical conductor strand, said at least one helical conductor strand is formed arc-shaped and is used for transmitting or receiving a signal and is connected to said transmitting and receiving unit disposed in said housing.

2. The hearing aid according to claim 1, wherein said at least one helical conductor strand of said arc-shaped antenna element is one of at least two helical intertwined conductor strands.

3. The hearing aid according to claim 2, wherein one of said at least two intertwined helical conductor strands is grounded.

4. The hearing aid according to claim 1, wherein said at least one helical conductor strand is one of at least three helical conductor strands.

5. The hearing aid according to claim 2, wherein said at least two helical intertwined conductor strands are open at an end.

6. The hearing aid according to claim 2, wherein said at least two helical intertwined conductor strands are directly connected to one another at an end and short-circuited.

7. The hearing aid according to claim 2, wherein an impedance of said arc-shaped antenna element is set by a number of said at least two helical intertwined conductor strands.

8. The hearing aid according to claim 1, wherein said at least one helical conductor strand extends from a first end at a beginning of said arc-shaped antenna element to a second end at an end of said arc-shaped antenna element.

9. The hearing aid according to claim 1, wherein a number of turns of said at least one helical conductor strand is selected such that a desired transmitting and receiving frequency is set.

10. The hearing aid according to claim 1, wherein said arc-shaped antenna element has a curved carrier, around said curved carrier said at least one conductor strand is helically wound.

11. The hearing aid according to claim 10, wherein said at least one conductor strand is formed by a metallization applied to said curved carrier.

12. The hearing aid according to claim 1, wherein said at least one conductor strand is formed by laser structuring.

13. The hearing aid according to claim 1, wherein said arc-shaped antenna element is detachably attached to said housing via a coupling point.

14. The hearing aid according to claim 1, wherein said arc-shaped antenna element forms a half arc, wherein one end of said arc-shaped antenna element is oriented again in a direction toward said housing.

15. The hearing aid according to claim 1, wherein said arc-shaped antenna element only extends above a surface area formed by an end wall of said housing and does not protrude laterally beyond said housing.

16. The hearing aid according to claim 7, wherein the impedance of said arc-shaped antenna element is set to a value of 50 ohm.

17. The hearing aid according to claim 9, wherein the desired transmitting and receiving frequency is set at 2.4 GHz.

18. The hearing aid according to claim 2, wherein all said helical intertwined conductor strands are formed by laser structuring.

19. The hearing aid according to claim 13, wherein said coupling point is a socket.

20. The hearing aid according to claim 4, wherein several of said helical conductor strands are grounded.
